(19) United States
(12) Patent Application Publication
(10) Pub. No.: US 2007/0173974 A1
(43) Pub. Date: Jul. 26, 2007

(54) Device and method for interacting with autonomous robot

(76) Inventor: Chyi-Yeu Lin, Taipei (TW)

Correspondence Address: LIN & ASSOCIATES INTELLECTUAL PROPERTY, P.O. BOX 2339, SARATOGA, CA, 95070-0339, US

(21) Appl. No.: 11/339,381

(22) Filed: Jan. 25, 2006

(51) Int. Cl. G06F 19/00

(52) U.S. Cl. 700/245

(57) ABSTRACT

A novel device and a related method are provided for use with a trigger-and-respond autonomous robot. The device functions both as an electronic repository of graphical images, each containing an encoded instruction, and a presentation mechanism of the encoded instructions to the autonomous robot. The device contains the following major components: an output means both as a display to the user and a display of graphical images to the autonomous robot; an input means via which the user can perform various point-and-select tasks; a non-volatile information repository for storing graphical images; and an organization means which organizes and presents the graphical images in a tree-like or hierarchical manner for efficient search and retrieval.

### BACKGROUND OF THE INVENTION

1. Field of the Invention

The present invention generally relates to autonomous robots, and more particularly to a device and method for interacting with an autonomous robot.

2. The Prior Arts

An autonomous robot is a robotic device that can independently respond to external stimulus without human involvement. Recent researches have made significant progresses in making autonomous robots to communicate via natural means such as vision and voice. Despite still quite primitive, autonomous robots have found an application area in the household as an educational/entertainment means to children, as communicating with children in such context is much less complex relative to the interaction with adults, and interaction with the robot is quite interesting to the children compared to conventional educational means and toys.

Most of the autonomous robots interact with the children in a trigger-and-respond manner. Usually the autonomous robot is equipped with a number of control buttons on the body, or the control buttons are provided on a wired or wireless control box. A child engages a control button to trigger a response from the autonomous robot such as singing a nursery rhyme or song, telling a story or joke. For more in-depth learning activities and for learning more complex subjects, the control button-based interaction is inadequate. To overcome the limitation of control buttons and to give the children an intuitive means to interact with the autonomous robot, some existing autonomous robot, such as the Sony® AIBO® robotic dog, is equipped with a camera, and physical pictorial cards having graphical images on a side with encoded instruction are employed to trigger the autonomous robot to change specific settings (e.g., from a “story-telling” mode to a “spelling teaching” mode), to perform specific actions (e.g., dancing with self-playing music), or to deliver specific information retrieved from an information repository stored in the autonomous robot (e.g., pronouncing a word in the “spelling-teaching” mode).

Abstractly, the graphical images on the pictorial cards are “cues” to trigger the autonomous robot to deliver corresponding “answers.” Please note that, as described, the answers may involve internal setting change, action, information delivery, or a combination of the foregoing. Please also note that each of the graphical images usually contains two parts: a human-recognizable portion and an encoded instruction for the recognition of the autonomous robot. It is the encoded instruction that is meaningful to the autonomous robot. The encoded instruction is usually arranged at specific locations with specific colors and/or patterns on a card so that the autonomous robot can identify the encoded instruction and distinguish it from the human-recognizable portion easily. It is possible to have the autonomous robot to recognize the entire graphical image directly (i.e., the graphical image itself is the encoded instruction). For simplicity, the term “graphical image” is used hereinafter to refer to both the human-recognizable portion and the encode instruction contained in the image.

For example, an autonomous robot has a grade-school-spelling course (here, the term “course” is referred to a set of information related to a specific topic or within a specific category.) to teach a child the spelling of a set of words (i.e., answers). Each of the words has its graphical representation drawn on a card. A child picks up a card having the picture of a house and shows the card to the camera of the autonomous robot. The autonomous robot captures the image of the card, recognizes the image (or, more specifically, the encoded instruction contained in the graphical image), search for the answer, and spell out the word ‘house’ via a built-in speaker. Using pictorial cards to interact with the autonomous robot can be applied to various other learning activities. For instance, a card drawn with stars will trigger the autonomous robot to sing the song “twinkle, twinkle, little star” from a nursery-rhyme course; a card drawn with a music note on a staff will trigger the autonomous robot to play the note from an introduction-to-music course.

Using visual cues such as the pictorial cards to trigger the autonomous robot is an intuitive yet powerful communication means. However, managing and searching a large pile of cards is time consuming and the effort involved would certainly discourage the young and eager mind. A number of factors also significantly impair the visual cue-based interaction. For instance, the reliable recognition of a graphical image by the autonomous robot is highly dependent on the illumination condition of the card; if there is insufficient lighting, the autonomous robot may misinterpret the card and provide irrelevant or incorrect answer, which surely will frustrate and mislead the participating children. The images on the cards would be stained or worn off after a period of usage, adding additional difficulties in successful recognition. If there are a large number of cards, a more complex encoding system is required for preparing the encoded instructions on the cards, implying a higher failure rate or requiring a higher-precision high cost camera. Further more, some learning activities such as arithmetic and mathematics are inherently inappropriate for card-based interaction, as the cards can only embody a limited number of mathematic problems with fixed numbers. Some approach uses a white board to write down mathematic problems and let the autonomous robot to recognize the handwriting. As can be imagined, the recognition rate is not satisfactory especially for young learners who cannot write clearly. Some approach provides pre-prepared printed mathematic operators and numbers so that various mathematic problems can be pieced together. This approach indeed achieves higher recognition rate, but it is at the cost of an even larger pile of cards to manage.

### SUMMARY OF THE INVENTION

Accordingly, a novel device and a related method are provided which obviate the foregoing shortcomings of prior approaches in presenting cues to an autonomous robot.

The device is a computing device similar to a PDA or a tablet PC which functions both as an electronic repository of graphical images and a display for the graphical images. Presenting a graphical image to an autonomous robot is achieved either by a user holding the device to show the displayed graphical image to the camera of the autonomous robot, or by converting the encoded instruction of the graphical image into an electrical signal and sending the electrical signal to the autonomous robot. In other words, the graphical image is presented to the autonomous robot either as a visual cue as in the former case, or as an electrical cue as in the latter case.

The device contains the following major components: an output means usually in the form of a panel screen both as a display to the user and a display to the autonomous robot; an input means usually in the form of a transparent touch panel overlaying the screen via which the user can perform various point-and-select tasks by a pen, a stylus, or fingers; a non-volatile information repository usually in the form of Flash ROM or magnetic disk drive for storing the graphical images; and an organization means which organizes and presents the graphical images in a tree-like or hierarchical manner for efficient search and retrieval.

The device further contains a wired or wireless communication means for communicating with the autonomous robot and/or other device. The communication means can transmit the electrical signal of a graphical image from the device to the autonomous robot to obtain an answer. The communication means is also used to install new or updated graphical images or other information onto the device from the autonomous robot or other device. The device can be an integral part of the autonomous robot that can be detached from the autonomous robot for remote operation, and restored to function as a control panel to the autonomous robot. The device is powered by an internal rechargeable battery which is re-charged by the AC mains from a wall outlet, or by the autonomous robot when the device is mounted. The information installation to the device can also be carried out when the device is mounted back to the autonomous robot.

The graphical image displayed by the device is in a stable and self-illuminating condition and the lighting problem of physical cards is therefore avoided. For a large number of graphical images, the device is able to apply a highly flexible yet reliable encoding system to control the details of the graphical images down to the pixel level without worrying the recognition rate of the autonomous robot. The key advantage of the device is that the answers are organized for the user to navigate efficiently, regardless of the number of the graphical images. For complex subjects such as mathematics, highly recognizable mathematic equations can be generated dynamically.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing the device according to an embodiment of the present invention.

FIG. 2 is a flowchart showing the processing steps of the method according to an embodiment of the present invention.

### DETAILED DESCRIPTION OF THE PREFERRED EMBODIMENTS

The device according to the present invention is for use with an autonomous robot, which is basically a computing device capable of responding to external triggers in a human-sensible, visual and/or audible manner independently. The autonomous robot is not required to have specific shape or body parts; whether it has a humanoid form or whether it has facial expression is irrelevant to the present invention. The autonomous robot contains one or more courses stored in a non-volatile information repository of the autonomous robot and, when a graphical image is presented, the autonomous robot responds with a corresponding answer.

The device of the present invention can be used with an autonomous robot which receives the graphical image visually, or electrically, or both. To accept graphical images in either form, the autonomous robot is equipped with appropriate input interface. For visual input, the autonomous robot contains an image capturing device such as a CCD camera to capture the graphical images and recognize the encoded instructions. For electrical input, the autonomous robot contains appropriate wired or wireless interface for receiving the electrical signals of the encoded instructions.

The autonomous robot can deliver an answer in various human-sensible manners. For example, the autonomous robot can contain an audio output device usually in the form of a speaker so that the autonomous robot speaks out the answer by synthesized, human-like voice or by playing a pre-recorded voice segment. The autonomous robot can also contain visual output device such as a screen for showing the answer visually. The delivery of the answer can also be accompanied by body movement of the autonomous robot such as “dancing” with the song being played, writing down the word being spelled, etc. Again, the present invention does not require the answer being delivered in a specific manner.

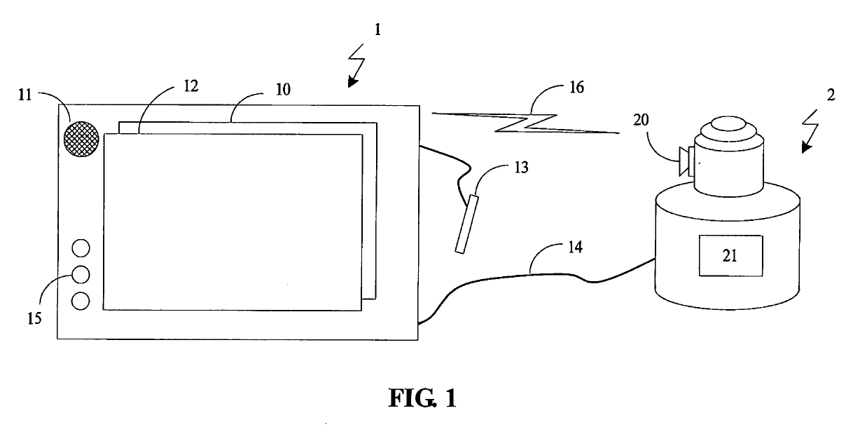

The device of the present invention is basically a computing device and can be imagined to be like a PDA or a tablet PC. Being referred to as a “computing device,” the device internally has conventional computer architecture with at least a central processing unit, memory, bus, I/O interface, controller, etc. As shown in FIG. 1, the device 1 has a form factor that is rather easy to hold in one or both hands with an output means such as a LCD panel 10 as the main man-machine interface for the user. The device also contains a non-volatile information repository internally (not shown), usually in the form of Flash ROM or magnetic disk drive, to store a number of graphical images. From the information repository to output means, an organization means (not shown) of the device 1, usually in the form of an application program, presents the graphical images to the user in an organized manner so that a young user can easily locate a graphical image of interest. For example, in learning spelling, the device 1 presents a number of categories using text or vivid graphics for the user to choose on the screen 10. When the user picks the category “Cars,” images of different kinds of cars are displayed on the screen 10. The user then can pick a car of interest. Once the graphical image of interest is shown on the screen 10, the user can show the graphical image on the screen 10 to the camera 20 of the autonomous robot 2. The autonomous robot 2 will then automatically respond by delivering the answer after recognizing the encoded instruction contained in the image as a cue.

In other words, the key benefit of the device is to house a large number of graphical images electrically and allows a user to navigate through them intuitively in an organized manner so that even a child can operate independently without guidance or help. In this way, a child can interact with the autonomous robot effectively and efficiently to achieve better learning progress. There are various ways to organize and present information in an organized manner to facilitate search. The most common one is a tree-like, top-down, from-general-to-specific approach. More interesting and metaphorical approaches are also possible such as arranging information as if they are books in libraries, sections, alleys, and shelves, etc. Again, the present invention does not impose specific requirement on how the graphical images are organized.

To allow the user to make selections and to interact with the device 1 and the autonomous robot 2, the device 1 provides an input means usually in the form of a transparent touch panel 12 overlaying the screen 10. The user can use his or her finger, a pen, or a stylus 13 connected to the device to tap the touch panel 12 in order to make selection or to activate some function of the device 1. The device can also contain an optional audio output device usually in the form of a speaker 11 through which interesting audio effect can be generated during the user's operation of the device 1. The device 1 can also contain a number of control buttons 15 for adjusting the brightness of the screen 10, the volume of the speaker 11, etc.

In addition to manually showing the graphical images to the autonomous robot, the device can convert the encoded instruction of a selected graphical image into an electrical signal and transmit the electrical signal to the autonomous robot via a wired or wireless communication means. Please note that it is encoded instruction, not the entire graphical image, that is converted and transmitted. The wired or wireless communication means can be implemented through various technologies such as using USB (universal serial bus) as a wired link 14, or using a wireless local area network (WLAN) or Bluetooth for wireless connection 16, just to name a few possibilities. The communication means can also be used for installing information onto the device 1, in addition to transmitting the encoded instruction. The autonomous robot 2 or other device (including another device 1 or another computing device) can upload, for example, additional or updated graphical images into the device 1, or the device 1 can download additional or updated graphical images from the autonomous robot 2 or from other device (including another device 1 or another computing device), both via the communication means.

The device 1 can also be an integral part of the autonomous robot 2. The device 1 can be mounted to a seat 21 on the autonomous robot 2 and become a part of the autonomous robot 2. If the device 1 uses wireless communication with the autonomous device 2, there are physical connectors on both the device 1 and the seat 21 so that the device 1 is automatically and electrically connected to the autonomous robot 2 when it is mounted in the seat 21. When the device 1 is physically attached to the autonomous robot 2 in this way, the device 1 can become a control panel to the autonomous robot 2 and the control of the autonomous robot 2 can be conducted via the mounted device 1, including the uploading/download information to the device. At any time, the device 1 can be detached from the autonomous robot for remote operation and control of the autonomous robot 2. The device 1 is powered by an internal rechargeable battery (not shown) which is re-charged by connecting to the AC mains via a power cable (not shown) plugging into a wall outlet. The device 1 can also be charged automatically when it is mounted in the seat 21 of the autonomous robot 2.

Please note that the autonomous robot 2 can interact with more than one device 1 and this would constitute an interesting learning environment. For example a teacher or a tutor is holding one device and a child is holding another. The teacher uses his or her device to instruct the autonomous robot to spell out the word “house” but concealing the graphical image from the child. The child is then asked to find out the graphical image of the word “house” from his or her own device. And the child can verify his or her guess by instructing the autonomous robot to spell out his or her finding. The device can also be used in learning more complex subjects such as mathematics. The device can generate a mathematic equation on the screen with the numbers being provided automatically and randomly.

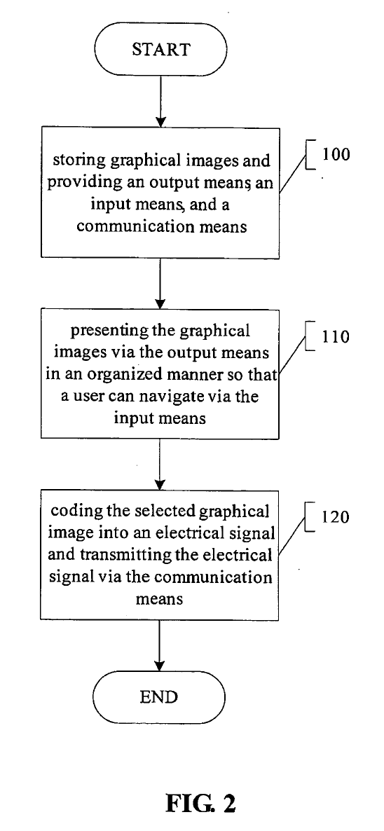

After understanding the operation of the device, the method provided by the present invention is quite straightforward. The method can be imagined to be implemented in a PDA or a tablet PC or even a cellular handset (e.g., those so called Smart Phones). FIG. 2 is a flow chart showing the processing steps of the method according to an embodiment of the present invention. As illustrated, the method starts by storing a plurality of graphical images electrically in a non-volatile information repository and providing an output means for displaying the graphical images, an input means for making selections among the graphical images, and a communication means for communicating with the autonomous robot, all in step 100. Then, in step 110, the method presents the graphical images via the output means in an organized manner so that a user can navigate through these graphical images via the input means. After the user has made a selection, in step 120, the graphical image is displayed on the output means and the encoded instruction is converted into an electrical signal and transmitted to the autonomous robot via the communication means.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A device for interacting with an autonomous robot, said autonomous robot capable of being triggered visually or electrically by an encoded instruction contained in a graphical image as a cue, and then responding visually or audibly to said cue with a corresponding answer, said device comprising:
a plurality of said graphical images, each containing an encoded instruction;
a non-volatile information repository for storing said graphical images;
an output means having a self-illuminating display;
an organization means for presenting said graphical images via said output means in an organized manner; and
an input means allowing a user to interact with said device to navigate through said graphical images and make selections of said graphical images;
wherein a graphical image selected by said user via said input means is displayed on said output means.

2. The device according to claim 1, wherein said autonomous robot contains a visual input device; said graphical image selected by said user via said input means and displayed on said output means is presented to said visual input device of said autonomous robot; and said autonomous robot recognizes said encoded instruction contained in said graphical image as said cue.

3. The device according to claim 1, further comprising a communication means capable of communicating electrically with said autonomous robot.

4. The device according to claim 3, wherein an encoded instruction of said graphical image selected by said user via said input means and displayed on said output means is converted to an electrical signal and transmitted to said autonomous robot as said cue via said communication means.

5. The device according to claim 3, said communication means is at least one of the following: an USB-based wired link, a WLAN-based wireless link, and a Bluetooth-based wireless link.

6. A method for interacting with an autonomous robot, said autonomous robot capable of being triggered visually or electrically by an encoded instruction contained in a graphical image as a cue, and then responding visually or audibly to said cue with a corresponding answer, said method comprising the steps of:
(1) storing a plurality of said graphical images, each containing an encoded instruction, in a non-volatile information repository, providing an output means having a self-illuminating display, and an input means;
(2) presenting said graphical images via said output means in an organized manner so that said user can navigate through said graphical images and make selections of said graphical images via said input means; and
(3) displaying a graphical image selected by said user via said input means on said output means.

7. The method according to claim 6, wherein said autonomous robot contains a visual input device; and said step (3) further comprises:
showing said graphical image selected by said user via said input means and displayed on said output means to said visual input device of said autonomous robot so that an encoded instruction of said graphical image is recognized by said autonomous robot as said cue.

8. The method according to claim 6, wherein said step (1) further comprises:
providing a communication means capable of communicating electrically with said autonomous robot.

9. The method according to claim 8, wherein said step (3) further comprises:
converting an encoded instruction of said graphical image selected by said user via said input means and displayed on said output means to an electrical signal and transmitting said electrical signal to said autonomous robot as said cue via said communication means.

10. The method according to claim 8, said communication means is one of the following: an USB-based wired link, a WLAN-based wireless link, and a Bluetooth-based wireless link.
